(19) United States
(12) Patent Application Publication
(10) Pub. No.: US 2007/0082170 A1
(43) Pub. Date: Apr. 12, 2007

(54) Wallboard with antifungal properties and method of making same

(75) Inventors: Elizabeth A. Colbert, Backlick, OH (US); Gary Molchan, Purcellville, VA (US); Bruce T. Wieder, Falls Church, VA (US)

Correspondence Address: BUCHANAN, INGERSOLL & ROONEY PC, POST OFFICE BOX 1404, ALEXANDRIA, VA, 22313-1404, US

(73) Assignee: LAFARGE PLATRES, Avignon (FR)

(21) Appl. No.: 11/512,082

(22) Filed: Aug. 30, 2006

Related U.S. Application Data
(60) Provisional application No. 60/712,402, filed on Aug. 31, 2005.

(51) Int. Cl. B05D 3/02; B05D 1/36; B32B 1/04

(52) U.S. Cl. 428/70; 106/779; 106/778; 427/403; 427/372.2

(57) ABSTRACT

This invention provides wallboard with a gypsum core with improved antifungal properties based on the distribution of fungicide and starch. Preferably, the wallboard has a gypsum core having a first surface and a second surface; facing sheets adhered to the first and second surfaces; a fungicide and a starch in the gypsum core; wherein the concentration of fungicide and starch is greater in portions of the core adjacent to the facing sheets than in a center of the core. Also a method for manufacturing wallboard as described above.

### BACKGROUND OF THE INVENTION

1. Technical Field

The present invention relates to a new wallboard with a gypsum core with improved antifungal properties based on the distribution of fungicide and starch. The invention also relates to a method for manufacturing wallboard as described above.

2. Description of the Related Art

Wallboard is a well known building product which is primarily used to form interior walls and ceilings. Conventionally, a slurry including calcium sulfate hemihydrate and water is continuously deposited from a mixer on a moving paper cover sheet to form a gypsum core. Moreover, starch is typically added to the gypsum slurry in order to improve the adhesion between the gypsum core and paper cover sheets. A second paper cover sheet is applied there over and the resultant assembly is formed into the shape of a wallboard panel. Calcium sulfate hemihydrate reacts with sufficient water to convert the hemihydrate into a matrix of interlocking calcium sulfate dehydrate crystals, causing it to set and become firm. The continuous strip thus formed is conveyed on a belt until the calcined gypsum is set, and the strip is thereafter cut to form boards of desired length, which boards are conveyed through a drying kiln to remove excess moisture.

Fungus may grow on most any surface were both moisture and nutrients are provided. Water vapor from the air can condense on a surface and nutrients may collect in the water. This may allow for fungus spores, which are typically prevalent in the air, to form a fungus on a such a surface. With regard to gypsum-based construction materials, naturally occurring organic matter that is a part of conventional gypsum-based construction materials, such as cellulose, paper fibers, starch and contaminants, serve as nourishment for many strains of fungus. Accordingly, when conventional gypsum-based construction materials become chronically moist or water damaged due to excessive humidity, water leaks, condensation, or flooding, fungus will grow in or on the gypsum board.

As used herein, the term fungicide encompasses all agents, materials, and combinations thereof providing antifungal activity. As used herein, the term fungal encompasses bacteria, fungi, and other life forms that are generally considered by those skilled in the art to fall within the realm of microbiology. Fungus, however, is a primary concern with wallboard. Accordingly, this description makes reference to fungicide and fungal but this method of presentation should not be considered as limiting the scope of the invention in any way.

As used herein, the term wallboard encompasses gypsum board products whether used in wall, ceiling or other surface applications.

Attempts to treat fungal growth are known. For example, U.S. Pat. No. 6,680,127 discloses the addition of fungicide to the gypsum core and/or to the paper facing sheets. However, adding an effective concentration of fungicide to the entire core results in added expense and certain fungicides may negatively affect certain properties of the core. Moreover, including the fungicide with the paper does not place an effective concentration of fungicide at the source of the problem, namely the portion of the wallboard with the nutrients for fungal growth.

U.S. Pat. No. 6,703,331 discloses a fungus resistant gypsum board. The board avoids the addition of starch to the gypsum core because starch is a fungal nutrient. Without the addition of starch, which aids in the adhesion of paper facing sheets, polymeric fibrous sheets are used instead of typical paper facing sheets. The patent does suggest the use of dense gypsum slurry to coat the polymeric fibrous sheets to provide improved wet adhesion. However, the patent still teaches that effective concentrations of fungicide should be added to the entire core of the wallboard.

U.S. Patent Application Publication No. 2004/0092625 discloses composite wallboard with strengthening agents in the core, so as to not require the use of paper facing sheets. The publication discloses that skim layers, which form a dense, smooth protective layer on one or more surfaces of the core layer and may incorporate a different additive, such as fungicide, from that of the core layer. The purpose of these skim layers is to protect the core layer which comprises strengthening agents so as to not need conventional facing sheets for strengthening the composite wallboard. The publication does not suggest the use of these skim layers to assist in the adhesion of paper facing sheets or the use of starch for such purposes.

U.S. Patent Application Publication No. 2004/0134585 discloses a process for manufacturing wallboard and a wallboard manufacturing unit is provided, the process including feeding hydratable calcium sulphate and water into a first mixer and into a second mixer; feeding in a facing; preparing a first gypsum slurry in the first mixer; preparing a second gypsum slurry in the second mixer; applying the first slurry onto the facing and forming a surface layer; applying the second slurry onto the surface layer and forming a core layer with a density lower than that of the surface layer; forming a wallboard; hydrating and drying the board. This process allows the formation of the different layers of gypsum to be controlled independently. The contents of U.S. Patent Application Publication No. 2004/0134585 are hereby expressly incorporated herein by reference. Further, U.S. Patent Application Publication No. 2004/0134585 is a by-pass continuation of PCT/FR02/01587, filed on May 10, 2002, and which claims the priority of French Patent Application No. 01/06381, filed on May 14,2001. The contents of PCT/FR02/01587 and French Patent Application No. 01/06381 are hereby expressly incorporated herein by reference.

As is evident from the above, there is a need for wallboard which has fungal resistance and reduced capital costs. Moreover, there is a need for a simple and cost-effective method for manufacturing the wallboard.

### OBJECTS AND SUMMARY

According to an embodiment of the present invention, wallboard has been produced which has a gypsum core having a first surface and a second surface; facing sheets adhered to the first and second surfaces; a fungicide and a starch in the gypsum core; wherein the concentration of fungicide and starch is greater in portions of the core adjacent to the facing sheets than in a center of the core.

According to another embodiment of the invention, wallboard has been produced which has a gypsum core layer having a first surface and a second surface; a first gypsum surface layer; a second gypsum surface layer; facing sheets adhered to the first and second surfaces; a fungicide and a starch in the first gypsum surface layer and the second gypsum surface layer; wherein the first gypsum surface layer adheres to the first surface of the gypsum core layer and the second gypsum surface layer adheres to the second surface of the gypsum core layer; wherein a concentration of fungicide and starch is greater in the first gypsum surface layer and the second gypsum surface layer than in the gypsum core layer.

Another embodiment of the invention is a process for manufacturing wallboard which involves mixing hydratable calcium sulphate, water, starch and fungicide in a first mixer into a first gypsum slurry; mixing hydratable calcium sulphate and water in a second mixer into a second gypsum slurry; feeding in a first facing; applying the first gypsum slurry onto the first facing and forming a first surface layer; applying the second gypsum slurry onto the first surface layer and forming a core layer, wherein a concentration of fungicide and starch is greater in the first surface layer than in the core layer; forming a second surface layer, wherein a concentration of fungicide and starch is greater in the second surface layer than in the core layer; applying the second surface layer on the core layer; forming wallboard; and drying the wallboard.

Thus, by these embodiments of the present invention, starch, which is the biggest contributor to the core fungal issue, can be substantially removed from the center of the gypsum core. Thus, the center of the gypsum board has fewer nutrients for fungal growth and there is less need for fungicide in the center of the gypsum core. Therefore, with the starch and fungicide located in the portions of the gypsum core adjacent to the facing sheets, starch is not wasted in the gypsum core, but instead located where it can aid in the adhesion to the facing, and fungicide is located at the heart of the problem where the fungal food source is. This provides for cost effective use of both starch and fungicide.

### BRIEF DESCRIPTION OF THE FIGURES

Embodiments of the invention will be described in greater detail below with reference to the illustrative embodiments shown in the accompanying drawings, in which:

FIG. 1 is a side view of a wallboard manufacturing unit;

FIG. 2 is a side view of a device for feeding hydratable calcium sulphate into the mixers;

FIG. 3 is a top view of the interior of a mixer according to an embodiment of the invention; and

FIG. 4 is a cross sectional view of the mixer in FIG. 3.

### DESCRIPTION OF PREFERRED EMBODIMENTS

One embodiment of the present invention is a wallboard comprising a gypsum core having a first surface and a second surface and facing sheets adhered to the first and second surfaces. The wallboard is manufactured by adding a fungicide and a starch into the gypsum core such that the concentration of fungicide and starch is greater in portions of the core adjacent to the facing sheets than in a center of the core. This provides wallboard that has an effective fungal resistance, but with less starch and fungicide used.

As used herein, the term fungicide encompasses all agents, materials, and combinations thereof providing antifungal activity. As used herein, the term fungal encompasses bacteria, fungi, and other life forms that are generally considered by those skilled in the art to fall within the realm of microbiology. Fungus, however, is a primary concern with wallboard. Accordingly, this description makes reference to fungicide and fungal but this method of presentation should not be considered as limiting the scope of the invention in any way.

Preferred antifungal agents are those of the type and in an amount effective for inhibiting the growth and/or formation of microbes such as bacteria and/or fungi. Any antifungal agent compatible with gypsum board composition and manufacturing processes and providing the desired biocidal, antifungal, antimycogen, antibacterial, and/or like activity in the gypsum board may be employed with the present invention. As will be readily apparent to one of skill in the art, a variety of antifungal agents are known including, for example, sodium pyrithione, zinc pyrithione, chlorhexidine, alexidine, cetyl pyridinium chloride, benzalkonium chloride, benzethonium chloride, cetalkonium chloride, cetrimide, cetrimonium bromide, glycidyl trimethylammonium chloride, stearalkonium chloride, hexetidine, triclosan, triclocarban, diiodomethyl-p-tolysulfone, thioperoxydicarbonic diamide (((H₂N)C)₂S₂) sold by DC Chemical Co. under the trade name of Thiram, benzimidazolyl methyl carbamate (3-lodopropargyl-N-butylcarbamate) sold by AH Sung Fine Chemical under the trade name of PAN 200P, Ag ion (Min 4%) sold by AH Sung Fine Chemical, sodium-2-pyridinethiol-1-oxyde (C₅H₄NOSNa) sold by Arch Chemicals under the trade name of Na-Omadine, zinc pyrithione (C₁₀H₈N₂O₂S₂Zn) sold by Arch Chemicals under the trade name of Zn-Omadine, heavy metal quinolinolate (e.g., comprising Cu, Ni, Fe, Cd, Hg, Ag or Zn), propiconazole, cetyl pyridinium chloride (NH₄ quaternary), phtalonitrile and butyl carbamate, mercapto pyridine N oxide, thiabendazole, diiodomethyl tolyl sulfone sold by Dow Chemicals under the trade name of Fungi Block, tebuconazole, thiabendazole, 3-iodo-2-propynyl butylcarbamate, 2,4,4,-trichloro-2 hydroxy diphenyl ether sold under the trade name of Triclosan, organosilane quaternary ammonium sold by Aegis under the trade name of AEM5772, 2-n-isothiazoline sold by Bayer under the trade name of Preventol, thiabendazole ((2-(4-Thiazolyl)Benzimidazol) sold by Bayer under the trade name of Metasol TK100, chloro-methyl-isothiazoline sold by Henkel under the trade name of P3-Ferrocid, cetyl pyridinium chloride (NH₄ quaternary), tetrachloroisophtalonitrile (CTL), 3-iodo-2-propyly butyl carbamate (IPBC), Acticide BX sold by Thor, Mergal 721 K3 sold by Trisan, and organozilane. Mineral acids, such as boric acid, may also be used as antifungal agents. Preferred antifungal agents include sodium omadine, sodium pyrithione, and zinc pyrithione.

In this embodiment, the concentration of fungicide in the portions of the gypsum core adjacent to the facing sheets is preferably 25-4000 ppm, more preferably 50-2000 ppm, more preferably 300-1000 ppm. With regard to mineral acids, such as boric acid, the preferred concentration of fungicide in the portions of the gypsum core adjacent to the facing sheets is preferably 0.001-0.2 lbs/ft².

By portions of the gypsum core adjacent to the facing sheets is generally meant portions of the gypsum core at the first and second surfaces up to a depth of about 1/32 to about ⅛ inches, preferably ⅛ inch.

Starch is preferably supplied to the core such that the concentration of starch in the portions of the gypsum core adjacent to the facing sheets is preferably 0.1 wt % -1.8 wt % (based on total weight of stucco), more preferably 0.3 wt % to 1.2 wt % and even more preferably 0.4 wt % -0.7 wt % (based on total weight of stucco).

In a preferred embodiment of the present invention, the center of the gypsum core is substantially free of starch and fungicide. This allows for a more economical distribution of starch and fungicide, while still providing a wallboard with good adhesion properties to the facing sheets and effective antifungal properties.

The facing sheets for the wallboard may be any known facing sheet compatible with the gypsum core, typical wallboard applications, and wallboard manufacturing processes. Preferably, the facing sheets are made out of paper. A facing may also be made out of glass or polymer fiber, for example glass fiber mat, in order to provide good fire resistance. Additionally, it is within the scope of embodiments of the present invention to provide a facing that comprises fungicide. The fungicide, for example, may be sprayed or coated onto a paper facing. In one preferred embodiment, paper facing sheets are treated with zinc pyrithione.

In a preferred embodiment of the present invention, wallboard has a gypsum core layer having a first surface and a second surface, a first gypsum surface layer and a second gypsum surface layer. The wallboard has the first gypsum surface layer adhered to the first surface of the gypsum core layer and the second gypsum surface layer adhered to the second surface of the gypsum core layer. The wallboard has facing sheets adhered to the first and second surface layers. A fungicide and a starch included in the first gypsum surface layer and the second gypsum surface layer so that the concentration of fungicide and starch is greater in the first gypsum surface layer and the second gypsum surface layer than in the gypsum core layer.

Preferably, the gypsum core layer is substantially free of fungicide and starch.

Moreover, in addition to being able to economically distribute fungicide and starch in gypsum surface layers surrounding the gypsum core layer, this wallboard can also be manufactured such that the first gypsum surface layer and the second gypsum surface layer have a different density to that of the gypsum core layer. The first gypsum surface layer and second gypsum surface layer may also have different densities.

Preferably, the first gypsum surface layer and the second gypsum surface layer have a higher density (kg/L) than that of the gypsum core layer.

Preferably, the first gypsum surface layer slurry and the second gypsum surface layer slurry have a density of between 1.2 and 2 kg/L compared to gypsum core layer slurry which preferably has a density of between 1 and 1.2 kg/L.

Additionally, it is preferred that the first gypsum surface layer and the second gypsum surface layer have a density of between 0.8 and 1.2 kg/L after drying while the gypsum core layer preferably has a density of between 0.6 and 1.2 kg/L after drying.

It has been found that a preferred ratio of gypsum surface layer density to gypsum core layer density is between 1 and 1.5 after drying.

In an embodiment of the present invention, the first gypsum surface layer and the second gypsum surface layer have a thickness of between 0.1 and 0.5 mm after the formation of the board.

The present invention also contemplates a process for manufacturing wallboard with an economical distribution of starch and fungicide. One embodiment involves mixing hydratable calcium sulphate, water, starch and fungicide in a first mixer into a first gypsum slurry, mixing hydratable calcium sulphate and water in a second mixer into a second gypsum slurry, feeding in a first facing, applying the first gypsum slurry onto the first facing and forming a first surface layer, applying the second gypsum slurry onto the first surface layer and forming a core layer, wherein a concentration of fungicide and starch is greater in the first surface layer than in the core layer, forming a second surface layer, wherein the concentration of fungicide and starch is greater in the second surface layer than in the core layer, applying the second surface layer onto the core layer, forming wallboard, and drying the wallboard.

One embodiment of the process involves the use of a manufacturing unit that comprises two independent mixers for preparing gypsum slurry. One mixer is used to form a surface layer on the facing, at least one other mixer is used to form a core layer on the surface layer, the core layer having a different composition to that of the surface layer, such as different concentrations of starch and fungicide.

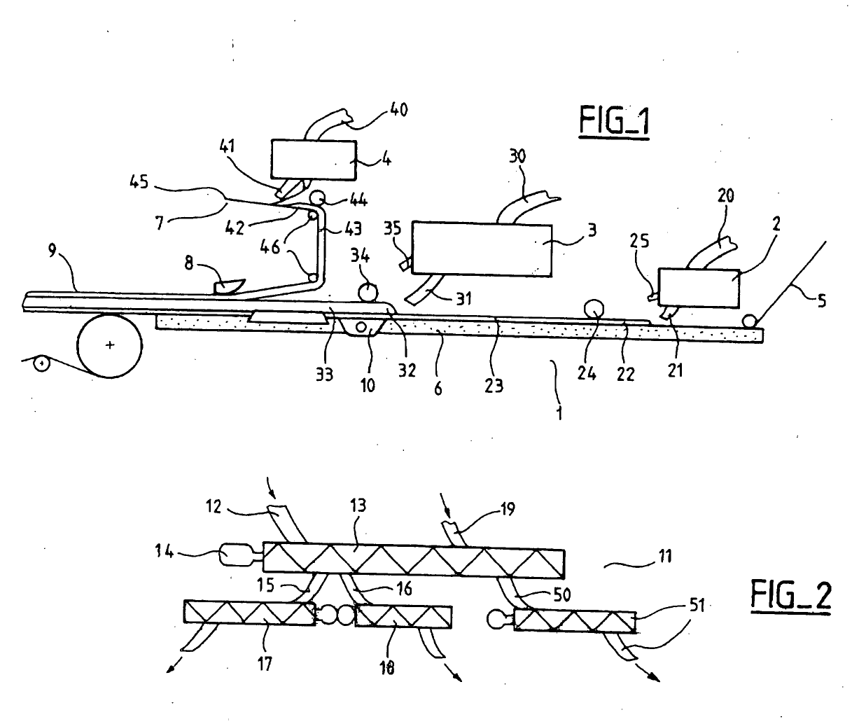

FIG. 1 shows a side view of a preferred manufacturing unit 1 for wallboard, where the process direction is right to left. This unit has three rotor mixers 2, 3, and 4, fed with hydratable calcium sulphate and water via respective inlets 20, 30 and 40, for the preparation of three gypsum slurries. Each of inlets 20, 30 and 40 may optionally be a configuration of multiple inlets. Each mixer has a slurry outlet, which communicates with a corresponding duct 21, 31 and 41 for applying the slurry. A first facing 5 moves along a table 6 placed under the gypsum slurry duct outlets 21, 31, 41 of the mixers 2, 3 and 4. The mixers are placed one after each other along the direction that the first facing moves. A high density gypsum slurry 22, comprising starch and fungicide, comes out of the first mixer, is applied onto the first facing and forms into a calibrated layer 23 by a roller 24. This layer 23 is the first surface layer. A low density gypsum slurry 32, preferably substantially free of starch and fungicide, comes out of the second mixer, is applied onto the first layer 23 and is formed into a calibrated layer 33 by a roller 34 and/or vibrating elements 10. This layer 33 is the core layer. The central plane of the wallboard is included in this core layer. A high density slurry 42, comprising starch and fungicide, comes out of the third mixer 4 and then is applied onto a second facing 7. This slurry 42 is formed into a calibrated layer 43 by a roller 44 and then applied onto the core layer 33. The assembly formed by the layers of gypsum and the facing sheets goes through a forming unit 8. A wallboard 9 comes out. This board 9 is then driven along and goes through a hydration unit, then a drying unit (not shown).

The manufacturing unit 1 in FIG. 1 thus has at least one mixer 2 for preparing a gypsum slurry intended to form a surface layer 22. This mixer 2 is independent of the second mixer 3 for preparing a gypsum slurry intended to form a core layer 32. It is thus possible to create a core layer 33 and a surface layer 23 in the wallboard, these layers having different physical properties. This manufacturing unit also enables the composition of one or two layers in the wallboard to be selectively changed without affecting the characteristics of the other layers. One may, for example, adapt the composition of a surface layer to the facing on which this layer is applied, by using different mixing ratios in the mixers. It is also possible to vary the flow rate or the quantity of an additive, such as starch or fungicide, in only one of the layers. It is then, for example, possible to modify the characteristics of one layer in wallboard while continuing to produce in a continuous manner. The use of several mixers allows small mixers to be used. Moreover, it is possible to use different gypsum powders in the different mixers.

Furthermore, the size of the application ducts 21, 31 and 41 may thus be reduced by bringing the mixers closer to table 6. The risk of blocking the ducts with gypsum agglomerate is thus reduced. The mixer outlets are preferably placed at a distance of less than 1.5 meters from the table 6.

The manufacturing unit comprises means for driving along the first facing. This first facing may thus be driven along, for example, by a hydration line conveyor belt. This first facing 5 may be made to move along the flat table 6.

The application duct 21 conveys the first gypsum slurry from the mixer onto the facing 5. The slurry application duct 21 is situated at the most upstream point along the line the facing moves along. The outlet of this duct is placed over the facing 5 in order to apply the first slurry from mixer 2 onto this facing.

The roller 24 is placed downstream of the duct outlet 21 and enables a first surface layer with calibrated thickness to be formed, from the first gypsum slurry that has been applied. A roller is preferably used, whose speed of rotation and/or the distance in relation to the table 6 may be adjusted in order to make it possible to modify the thickness of the first surface layer. The roller also makes it possible to spread out the slurry over the full width of the facing 5.

The application duct 31 conveys the second gypsum slurry from the mixer 3 onto the first surface layer 23. The application duct 31 for the second gypsum slurry is placed downstream of the roller 24. The outlet of this duct is placed above the facing 5 and the surface layer 23.

The roller 34 is placed downstream of the outlet of the duct 31. The roller has a function of forming the core layer 33 from the second slurry, a function of calibrating the thickness of this core layer 33 and a function of spreading out the slurry of this layer and making it uniform.

In some embodiments the manufacturing unit is equipped with vibrating elements 10. The vibrating elements 10 make it possible to uniformly spread out the gypsum slurry over the whole width of the facing. Since the quantity of gypsum slurry applied to form the core layer is generally greater than the quantity of slurry used for the surface layers, it is particularly advantageous to place vibrating elements at the application zone for the second gypsum slurry.

The application duct 41 conveys the gypsum slurry from the mixer 4 onto the second facing sheet 7. The outlet of the duct is placed above the facing 7.

The roller 44 is placed downstream of the outlet of the duct 41. The roller also has functions of shaping, calibrating, spreading out and making uniform the slurry and the second surface layer 43.

In order to promote the adhesion of the surface layers 23 and 43 to their respective facing sheets 5 and 7, it is preferable to use a manufacturing unit in which the application of the corresponding gypsum slurries is achieved firstly on the facing sheets. In the example in FIG. 1, the facing sheets are firstly driven along substantially opposite directions. Thus, the initial drive direction of facing sheet 7 is opposite to the drive direction of the wallboard. Free or motor-driven rollers are used to invert the drive direction of the facing 7. It can be seen in FIG. 1 that the surface layer 43 is placed in a vertical position and then turned over before being applied onto the core layer 33. By making a third gypsum slurry with suitable viscosity, by adding, for example, additives or by modifying the mixing ratio, it is possible to prevent the surface layer 43 from dissociating from the facing sheet 7 or prevent this surface layer disintegrating.

Downstream of rollers 34 and 44, the second surface layer 43 is applied against the core layer 33. To do this, one may, for example, use one or several rollers that press against the facing sheet 7 in order to place the surface layer 43 in contact with the core layer 33. Downstream of the application zone between the second surface layer and the core layer, the assembly formed by the gypsum layers and the facing sheets goes through a passage between a forming plate 8 and the table 6. The distance between the forming plate and the table approximately determines the thickness of the wallboard 9 formed when it goes through the passage.

It is possible to install devices 25, 35, 45 for controlling and regulating the layers. One may, for example, use an optical beam to measure the quantity of slurry at the forming roller level. One may thus measure the distance between a sensor and an aggregate of slurry placed upstream of roller 34. This measurement may then be used to modify the flow rate of slurry from the mixer or to modify the quantity of water or foaming agent introduced into this mixer. The formation of each layer may thus be better controlled. The density of each layer produced thus varies extremely little during the manufacture of the wallboard.

The wallboard manufacturing process is thus stable.

Starch and/or fungicide can be introduced to gypsum slurry as either wet or dry additives. Starch and/or fungicide can be added directly to the mixers or can be combined with other additive inlet feeds. Preferably, starch and/or fungicide are added via screw conveyors when in the form of dry additives and added directly to an inlet when in the form of wet additives.

FIG. 2 shows a side view of a hydratable calcium sulphate feeding device 11 for the mixers 2, 3 and 4. Hydratable calcium sulphate and, if appropriate, solid or liquid additives such as foaming agents or adhesion promoting agents are introduced via an inlet 12 in a screw conveyor 13. The screw conveyor 13 is driven, for example, by a motor 14. The products introduced move along the screw conveyor 13. The screw conveyor 13 also makes it possible to mix the calcium sulphate and the different additives.

In the embodiment of the invention shown, the screw conveyor 13 has along its length two intermediate outlets 15 and 16. These outlets communicate with the inlet of two other screw conveyors 17 and 18. The screw conveyors 17 and 18 convey the products respectively to the first and third mixers 2 and 4.

The first screw conveyor 13 may, if necessary, comprise at least one other inlet 19 placed downstream of the two outlets 15 and 16. This inlet 19 enables additional additives to be introduced, such as glass fiber or foaming agents. The downstream extremity of the first screw conveyor 13 may communicate with the inlet 50 of another screw conveyor 51. This screw conveyor 51 conveys the initial products and the additional additives to the second mixer 3.

In other embodiments, screw conveyors 17 and 18 may have multiple inlets for varying multiple feeds and/or screw conveyors 17 and 18 may be comprised of multiple screws.

This embodiment of the invention allows a shared part of the feed circuit to be used for the three mixers. It also enables the composition of the products to be modified as a function of the mixer in which these products are introduced. Thus, it is possible to only insert starch and fungicide into the first and third mixers 2 and 4. It is also possible to add foaming agents (via, e.g., inlet 19) into the second mixer to reduce the density of the slurry.

The two intermediate outlets 15 and 16 may be combined into one outlet only, i.e. a “combined outlet.” Also, additional inlets may be foreseen on outlets 15 and 16, or on the combined outlet. These additional inlets may be used to introduce starch and/or fungicide into the first and third mixers.

The hydratable calcium sulphate feeding device 11 for the mixers 2, 3 and 4 may also be used in other arrangements. For example, in screw conveyor 13 intermediate outlets 15 and 16 may be combined into one outlet which feeds an intermediate screw conveyor (not shown) which then feeds screw conveyors 17 and 18. This arrangement allows for the one-time introduction of additives to both screw conveyors 17 and 18. Additionally, screw conveyor 13 may communicate directly with the second mixer 3, avoiding the need for screw conveyor 51.

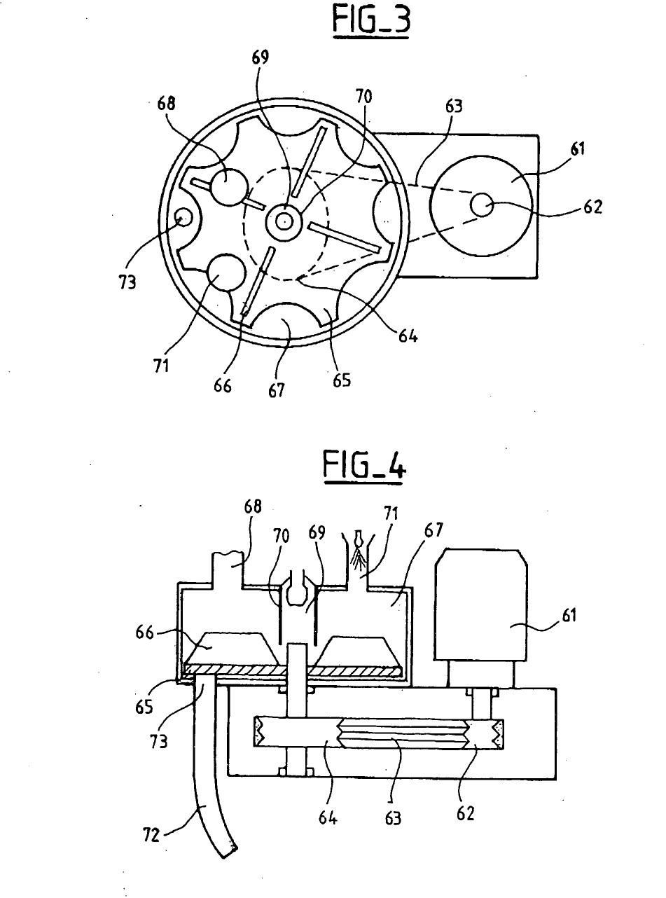

An embodiment of the process can also use a mixer shown schematically in FIGS. 3 and 4. In order to make the figures easier to understand, FIG. 4 represents an imaginary cross section through the main elements of FIG. 3. The mixer has a drive motor 61, a drive shaft 62, a rotor shaft 64, a transmission belt connecting shafts 62 and 64 and a rotor 65 integral with shaft 64.

The rotor 65 is, for example, mounted to rotate in a cylindrical mixing chamber 67. This rotor has, for example, a flat surface in the form of a disk, which has teeth at its radial extremities. The rotor may, if appropriate, have ribs 66, which spread out, for example, perpendicularly to the flat surface, in order to ensure better mixing of the gypsum slurry. Alternatively, the rotor may, if appropriate, have pins (not shown) to ensure better mixing of the gypsum slurry.

The mixer has a feed inlet 68 for calcium sulphate and other products that opens out in the mixing chamber. It also has a water feed 69 that opens out in the mixing chamber 67. The water in the water feed may comprise starch and/or fungicide. The hydratable calcium sulphate, the additives and the water are mixed by the rotor 65 in order to form a homogeneous gypsum slurry.

The feed 69 is arranged to project water at the centre of the rotor 65. It is, for example, introduced in a sleeve 70 that overhangs the rotor axis. Under the effect of the rotation of the rotor, the water that is introduced moves over the flat surface of the rotor towards the exterior of the mixing chamber and cleans the flat surface. Any aggregates of gypsum slurry are thus removed from the flat surface. This water also makes it possible to impregnate the calcium sulphate as well as any additives.

Secondary water feeds (not shown) may also be added at various locations to increase the flow of water and/or to keep mixer and rotor surfaces clean. One feed may, for example, inject water at the level of the calcium sulphate feed duct 68.

The mixer also has an outlet 73 located in the bottom of the mixing chamber 67. Alternatively, outlet 73 may be located in the sidewall of the mixing chamber 67. This outlet is arranged radially towards the exterior of the mixing chamber in order to evacuate the gypsum slurry that is centrifuged by the rotation of the rotor. A feed duct 72 is placed at the level of this outlet and makes it possible to apply the gypsum slurry formed onto a facing, for example.

The mixer may also have a vent hole 71 that opens out in the mixing chamber. This vent hole 71 is placed above the mixing chamber 67. Its purpose is to remove dust suspended in the mixing chamber. When the rotor rotates, dust filled air goes through the vent hole and is evacuated. A water injection point may be placed in the vent hole to solubilize the dust and incorporate it into the gypsum slurry. This reduces dust coming out of the vent hole.

The feed inlet 68 for hydratable calcium sulphate, the vent hole 71 and the outlet 73 of the mixing chamber are arranged relative to each other in a preferential manner. If it is taken that the rotor turns in a clockwise direction in FIG. 3, the calcium sulphate inlet is preferably arranged soon after the chamber outlet when viewed in a direction of rotation of the rotor. Thus, the gypsum powder and the additive are turned at least one full cycle in the mixing chamber 67 before being evacuated. The powder may thus be better impregnated with the water. Moreover, the vent hole 71 is, preferably, arranged shortly before the mixer outlet when viewed in a direction of rotation of the rotor. The majority of the dust generated at the powder inlet is thus impregnated in the water before reaching the vent hole. Due to the distance between the vent hole and the calcium sulphate feed, the vent hole thus has decreased dust to deal with.

The mixer may also have a feed for setting retarder that opens out in the mixing chamber. The mixer may also have a separate feed for other additives. These feeds may also be individually regulated. All of the quantities of additives may thus be controlled directly at the mixer level. The dosing of the gypsum slurry to be formed may thus be very accurate.

According to an embodiment, hydratable calcium sulphate and water are fed into the first, second and third mixers 2, 3 and 4. Starch and fungicide are also fed into the first and third mixers 2 and 4. Gypsum slurries are thus prepared in each of the mixers. These gypsum slurries are prepared in such a way as to obtain a slurry in the second mixer, the density of which is lower than that of the slurries in the first and third mixers. Several gypsum slurries with identical densities but with different physical properties, for example different tensile strengths or different fillers may also be prepared within the scope of the invention. Several parameters allow gypsum slurries with different densities to be obtained. It is thus possible to introduce different foaming agents, to use different mixing ratios, or to use different mixer rotating speeds or to use different fillers or additives.

The first gypsum slurry with starch and fungicide from the first mixer is then applied to the first facing. A first surface layer is thus formed. This layer may be rendered uniform, spread out and calibrated as described previously.

The second gypsum slurry, preferably substantially free from starch and fungicide, from the second mixer is then applied over the first surface layer. A core layer is thus formed with a density lower than that of the first surface layer. This core layer may also be rendered uniform, spread out and calibrated.

The third gypsum slurry with starch and fungicide from the third mixer is applied onto the second facing. A second surface layer is thus formed with a density higher than that of the core layer. As in the example of FIGS. 1 and 2, it is preferable to form the second surface layer on the second facing beforehand. The facing and the surface layer formed are then turned over and applied to the core layer. This turning over operation may be achieved by using the return rollers 46, which allow the facing 7 to be deviated. These rollers act on the face of the facing opposite the face that receives the third gypsum slurry. Thus, the layer 43 is not deformed by the rollers 46. These rollers may also be motor-driven to drive along the facing 7.

The second surface layer is then applied over the core layer. The assembly may then be calibrated as described previously.

The wallboard formed thereof then hydrates while allowing the gypsum to set. The board is then dried to remove excess water from the board.

This process also allows gypsum slurries with very different densities and different concentrations of starch and fungicide to be prepared independently. One can thus obtain a high density surface layer, which promotes adhesion between the surface layer and the facing. Moreover, a high density surface layer can comprise starch to further aid in adhesion between the surface layer and the facing, while the core layer does not need to contain starch. Without starch in the core layer, a major nutrient for fungal growth is removed and fungicide need only be added to the surface layer. Thus, there is a cost effective use of both starch and fungicide. Also, a high density surface layer resists calcination better in the drier. The risk of producing defective boards is thus reduced. One can thus reduce or eliminate the addition of anti-calcination additives such as tartric acid. A high density surface layer also rigidises the whole board. Thus, the higher the density of the surface layer, the more the density of the core layer may be reduced. In this way, lightweight wallboard can be produced.

It is thus possible to prepare a gypsum slurry with a density of between 1.2 and 1.6 kg/L in the first and third mixers, which is then used to form the surface layers. It is possible, if necessary, to prepare a gypsum slurry with a density of between 1.6 and 2 kg/L. It is also possible to prepare a gypsum slurry in the second mixer with a density of between 1 and 1.2 kg/L, which is then used to form the core layer. A ratio of 1.1 and 1.6 between the density of the surface layers and the density of the core layer is particularly suitable.

The wallboard obtained after drying is also characterized by the densities of the different layers. Due to the evaporation during drying, the final density of the layers is less than the density of the layers as first formed. Dried surface layer densities of between 0.8 and 1.2 kg/L are thus obtained. The density of the core layer is between 0.6 and 1.2 kg/L. The ratio between the density of the surface layers and the density of the core layer is also preferably between 1 and 1.5 after drying.

Tests have shown that the bond between layers with different densities is sometimes damaged. This may be remedied by adjusting the hydration rates for each of the layers, while ensuring that the hydration rate of the core layer is faster than the hydration rate of the surface layers.

The surface layers formed have, preferably, a thickness of between 0.1 and 0.5 mm. A thickness of 0.3 mm is particularly suitable to rigidify the wallboard and harden at least one of its faces.

Obviously, the present invention is in nowise limited to the examples of the embodiments of the invention described and represented, but it may be subject to numerous variations accessible to those skilled in the art. Although we have previously described a manufacturing unit comprising two or three mixers, a manufacturing unit comprising other numbers of mixers to produce the surface layers remains within the scope of the appended claims. Although in the process described, we have described the formation of two surface layers, the formation of a single surface layer is also within the scope of the appended claims. Moreover, the possibility of using different sources of gypsum for the different layers is also within the scope of the appended claims.

We claim:

1. A wallboard comprising:
a gypsum core having a first surface and a second surface;
a facing sheet adhered to the first surface;
a fungicide and a starch in the gypsum core;
wherein a concentration of fungicide and starch is greater in portions of the core adjacent to the facing sheet than in a center of the core.

2. The wallboard of claim 1, wherein a second facing sheet is adhered to the second surface and wherein the concentration of fungicide and starch is greater in portions of the core adjacent to the second facing sheet than in the center of the core.

3. The wallboard of claim 1, wherein the concentration of fungicide in the portions of the gypsum core adjacent to the facing sheet is 25-4000 ppm.

4. The wallboard of claim 3, wherein the concentration of starch in the portions of the gypsum core adjacent to the facing sheet is 0.1 wt % -1.8 wt % based on the total weight of stucco.

5. The wallboard of claim 1, wherein the center of the gypsum core is substantially free of starch and fungicide.

6. The wallboard of claim 1, wherein the facing sheet comprises paper or glass fiber.

7. The wallboard of claim 6, wherein the paper facing sheet comprises fungicide.

8. A wallboard comprising:
a gypsum core layer having a first surface and a second surface;
a first gypsum surface layer;
a facing sheet adhered to the first surface layer;
a fungicide and a starch in the first gypsum surface layer;
wherein the first gypsum surface layer adheres to the first surface of the gypsum core layer;
wherein a concentration of fungicide and starch is greater in the first gypsum surface layer than in the gypsum core layer.

9. The wallboard of claim 8, further comprising
a second gypsum surface layer;
a facing sheet adhered to the second surface layer;
a fungicide and a starch in the second gypsum surface layer;
wherein the second gypsum surface layer adheres to the second surface of the gypsum core layer;
wherein a concentration of fungicide and starch is greater in the second gypsum surface layer than in the gypsum core layer.

10. The wallboard of claim 8, wherein the gypsum core layer is substantially free of fungicide and starch.

11. The wallboard of claim 8, wherein the concentration of fungicide in the gypsum surface layer is 25-4000 ppm.

12. The wallboard of claim 11, wherein the concentration of starch in the gypsum surface layer is 0.1 wt % -1.8 wt % based on the total weight of stucco.

13. The wallboard of claim 8, wherein the facing sheet comprises paper or glass fiber.

14. The wallboard of claim 13, wherein the paper facing sheet comprises fungicide.

15. The wallboard of claim 9, wherein the first gypsum surface layer and the second gypsum surface layer have a thickness of between 0.1 and 0.5 mm after the formation of the board.

16. A process for manufacturing wallboard, the process comprising:
mixing hydratable calcium sulphate, water, starch and fungicide in a first mixer into a first gypsum slurry;
mixing hydratable calcium sulphate and water in a second mixer into a second gypsum slurry;
feeding a first facing sheet;
applying the first gypsum slurry onto the first facing sheet and forming a first surface layer;
applying the second gypsum slurry onto the first surface layer and forming a core layer such that a concentration of fungicide and starch is greater in the first surface layer than in the core layer;
forming wallboard; and
drying the wallboard.

17. The process of claim 16, further comprising:
feeding a second facing sheet; and
forming a second surface layer between the second facing sheet and the core layer such that a concentration of fungicide and starch is greater in the second surface layer than in the core layer.

18. The process of claim 16, wherein the core layer is substantially free of fungicide and starch.

19. The process of claim 16, wherein the concentration of fungicide in the surface layer is 25-4000 ppm.

20. The process of claim 19, wherein the concentration of starch in the surface layer is 0.1 wt % -1.8 wt % based on the total weight of stucco.

21. The process of claim 16, wherein the facing sheet comprises paper or glass fiber.

22. The process of claim 16, wherein the paper facing sheet comprises fungicide.

23. The process of claim 17, further comprising:
mixing hydratable calcium sulphate, water, starch and fungicide in a third mixer into a third gypsum slurry such that the second surface layer is formed from the third gypsum slurry.

24. The process of claim 23, further comprising applying the third gypsum slurry onto the second facing sheet.

25. The process of claim 24, wherein the third gypsum slurry is applied over the second facing sheet and in that the process comprises, after the application stage for the third gypsum slurry, a stage of turning over the second facing sheet.

26. The process of claim 23, wherein the first and third gypsum slurries are prepared in separate mixers.

27. The process of claim 16, wherein each said layer formation stage comprises an operation of spreading out a gypsum slurry.

28. The process of claim 16, wherein the first surface layer and the second surface layer have a thickness of between 0.1 and 0.5 mm after the formation of the board.

29. The process of claim 23, further comprising:
providing a common supply for hydratable calcium sulphate; and
providing a common supply for starch and fungicide.
